(19) United States
(12) Patent Application Publication
(10) Pub. No.: US 2010/0226085 A1
(43) Pub. Date: Sep. 9, 2010

(54) COMPUTER WRIST REST FOR NOTEBOOK COMPUTERS

(76) Inventor: Michael E. Zuckerman, Atlanta, GA (US)

Correspondence Address: MEREDITH & KEYHANI, PLLC, 330 MADISON AVE., 6TH FLOOR, NEW YORK, NY, 10017, US

(21) Appl. No.: 12/399,100

(22) Filed: Mar. 6, 2009

(51) Int. Cl. G06F 1/16

(52) U.S. Cl. 361/679.19

(57) ABSTRACT

An apparatus for relieving soreness and preventing repetitive stress on a portion of a user's hand while using a notebook computer, the apparatus comprising: an elongated pad portion smaller in width than the bottom portion of a notebook computer; a mousing opening cutout from the elongated pad portion and adapted to surround the mousing portion of a notebook computer to create a left portion, center portion and right portions; a first raised portion smaller in length and width than an elongated pad portion and integrally attached to an elongated pad portion along a left portion; a second raised portion smaller in length and width than the elongated pad portion and integrally attached to the elongated pad portion along the right portion; at least one keyboard button opening in the elongated pad portion along the center portion below the mousing opening cutout.

This application claims priority to application number 29329115 entitled “Laptop Computer wrist rest” filed Dec. 9, 2008 and application number 29325442 entitled “Mouse Pad” filed Oct. 1, 2008.

The present invention relates to wrist rests for use with notebook or laptop style computers.

There are many different types of personal computers on the market, including desktop and laptop or notebook. As society becomes more mobile, notebook computers are a desirable computing solution. Lightweight notebook computers have the advantage of being lightweight and include peripherals (such as mousing devices, keyboard and screens) built into a single device. The placement of the integrated mouse pad is generally in a bottom portion below the keyboard in a laptop computer. While this is very convenient and compact, it may cause significant trauma to the hand, requiring mousing at an awkward angle.

As the number of computer users has increased the number of repetitive stress disorders has also increased. Carpal tunnel syndrome is a common problem among computer users and may be characterized by a tingling, numbness, loss of gripping. Another problem is irritations, from repetitive contact with hard computer parts.

In a notebook computer, to correct the issue, the user may plug in a second mouse and use a mouse pad. While this may address the problem, it is cumbersome and requires the computer user to have a second mouse and large mouse pad. Also, some users prefer the style and mousing mannerisms of the incorporated mouse. The present invention addresses these issues by providing a wrist rest for use with the integrated mousing device of a notebook computer.

These and other features, aspects and advantages of the present invention will become better understood with reference to the following description and claims.

### SUMMARY OF THE INVENTION

The present invention relates to wrist rests for use with notebook or laptop style computers.

According to one embodiment of the present invention, an apparatus for relieving soreness and preventing repetitive stress on a portion of a user's hand while using a notebook computer, the apparatus comprising: an elongated pad portion smaller in width than the bottom portion of the notebook computer; a mousing opening cutout from the elongated pad portion and adapted to surround the mousing portion of the notebook computer to create a left portion, center portion and right portion; a first raised portion smaller in length and width than the elongated pad portion and integrally attached to the elongated pad portion along the left portion; a second raised portion smaller in length and width than the elongated pad portion and integrally attached to the elongated pad portion along the right portion; and at least one keyboard button opening in the elongated pad portion along the center portion below the mousing opening cutout.

According to another embodiment of the present invention, an apparatus for relieving soreness and preventing repetitive stress on a portion of a user's hand while using a notebook computer, the apparatus comprising: an elongated pad portion smaller in width than the bottom portion of the notebook computer; a mousing opening cutout from the elongated pad portion and adapted to surround the mousing portion of the notebook computer; a first raised portion smaller in length and width than the elongated pad portion and integrally attached to the elongated pad portion, the first raised portion curved being elevated towards the middle and tapered towards the mousing opening cutout.

These and other features, aspects and advantages of the present invention will become better understood with reference to the following description and claims.

### BRIEF DESCRIPTION OF THE DRAWINGS

FIGS. 1-15 depict the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

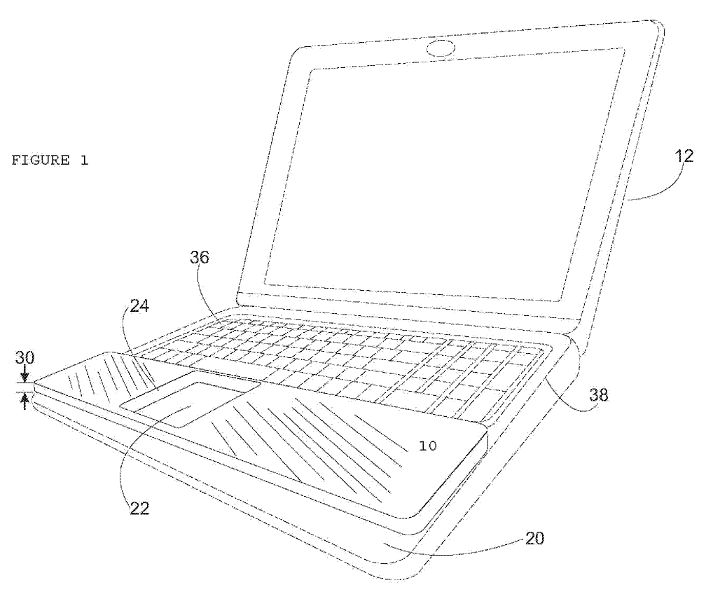

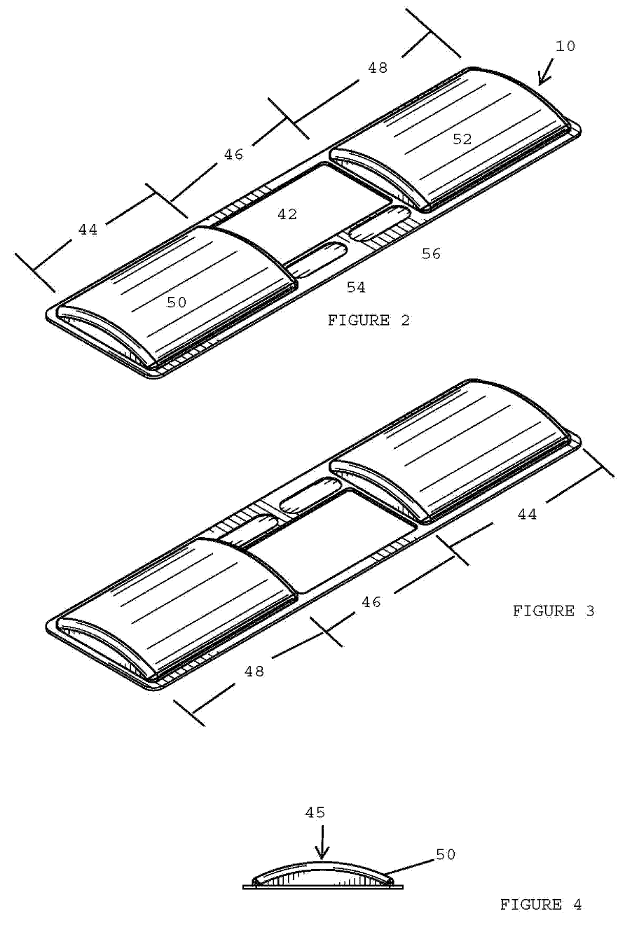

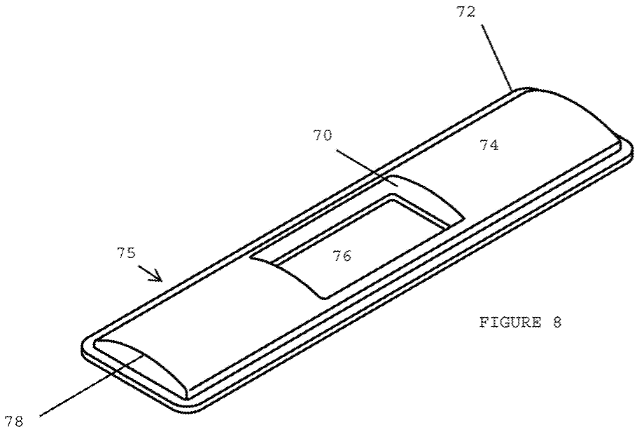

With reference to FIGS. 1-7, an apparatus (10) for relieving and preventing repetitive stress on a portion of a user's hand while using a the keyboard and/or mousing device on a notebook computer (12) is provided, the apparatus (10). FIG. 1 is intended to depict the placement of the apparatus (10) on a notebook computer. It should be made of a soft material that is typical of mouse pads, such as polyurethane foam. According to a preferred embodiment, the elongated pad portion is made from polyurethane foam covered in Lycra® which is the brand name for spandex or elastane which is a synthetic fiber known for its exceptional elasticity or other similar polyester or nylon, or antimicrobial treated fabrics. With reference to FIGS. 2-7, an apparatus (10) for relieving soreness and preventing repetitive stress on a portion of a user's hand while using a notebook computer (12) is provided, the apparatus comprising: an elongated pad portion (40) smaller in width than the bottom portion (20) of the notebook computer (12); a mousing opening (42) cutout from the elongated pad portion (40) and adapted to surround the mousing portion (22) or touchpad of the notebook computer (12) to create a left portion (44), center portion (46) and right portion (48); a first raised portion (50) is smaller in length and width than the elongated pad portion (40) and integrally attached to the elongated pad portion (40) along the left portion (44). There is also a second raised portion (52) smaller in length and width than the elongated pad portion (40) and integrally attached to the elongated pad portion (40) along the right portion (48). There may be at least one keyboard button opening (e.g. 54, 56) in the elongated pad portion (40) along the center portion (46) below the mousing opening cutout (42). This allows for clicking, or pressing mouse buttons that would be below each mousing opening cutout (42) in the laptop (12). The term bottom portion (20) of the notebook computer is intended to refer to the area below the keyboard on a laptop, where the mousing device (22) is incorporated. This may be important to note in the event the bottom portion is of a different width than the keyboard portion (which generally it is not). The apparatus (10) has a mousing opening (42) cutout from the elongated pad portion (40) adapted to surround at least a portion of the mousing portion (22) of the notebook computer. The terms notebook computer, laptop computer and portable computer are interchangeable and would be appreciated by those of skill in the art to refer to computer with a keyboard, mouse and monitor in a single apparatus. Also the terms touchpad and mousing portion are interchangeable and refer to the mouse incorporated in notebook computers. In each instance where the present invention recites a portion (such as the elongated pad portion) which surrounds at least a portion of the mousing portion this is intended to refer to it having an opening which allows for mousing in the opening and does not impede the ability of the user to perform that function. It may be an opening smaller than the entire mousing portion without departing from the present invention.

The elongated pad portion (40), according to a preferred embodiment is formed from foam, polyurethane gel, solid polyurethane or solid polyurethane gel (PU GEL) and is at least the same height (30) as the profile of the keys of the keyboard when sitting on the bottom portion (20) of the notebook computer (12). The profile of the keys (36) is intended to refer to the height of the keys (36) above the notebook computer casing (38). It is desirable to have the users wrist wrest at a height above the keys. The apparatus may also be made from visco-elastic polyurethane foam or Memory foam. Memory foam is made from polyurethane with additional chemicals that add to its viscosity level, increasing its density. Because of this, it is often referred to as visco-elastic polyurethane foam. Depending on the chemicals used and its overall density, it is firmer in cool temperatures and softer when warm. Higher density memory foam reacts to body heat which allows it to mould itself to the shape of a warm body within a few minutes. A lower density memory foam is pressure-sensitive and will mould more quickly to the shape of the body. The example often used to demonstrate its properties is that a hand pressed into the foam and then removed will leave a clear impression of the hand in the foam. Textured solid polyurethane may be formed during molding or may be textured by the additional of a course material (e.g. sand) or even a texture creating spray. If formed during molding, indentations and raised portions would form the texture.

As depicted in FIG. 6, there may be a thermoplastic polyurethane film (60) or a solid gripping neoprene base in communication with the underside of the elongated pad portion (40) and having a same sized cutout (42) as the mousing opening cutout. This prevents sliding. That is to say the film (60) is the exact size as the underside of the elongated pad portion (40) and serves to keep the apparatus (10) is place while mousing and typing. The film is unique as it adheres firmly to standard notebook/laptop style computer cases yet peels off without leaving any residue. There may also be an attachment means in communication with the underside of the elongated pad portion. The attachment means may be, for example, Velcro® hook and loop fasteners (100). Or a mechanical attachment means, such as clips.

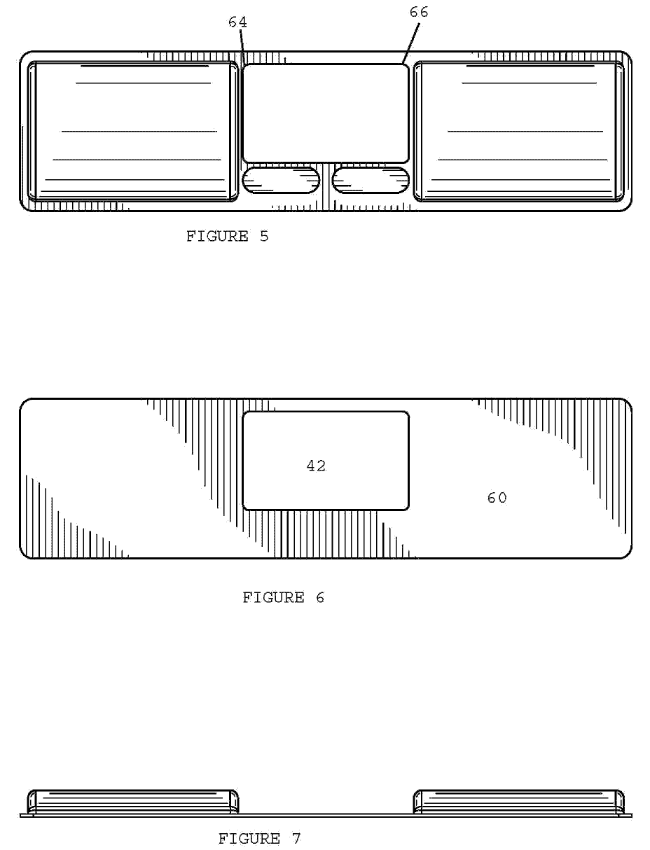

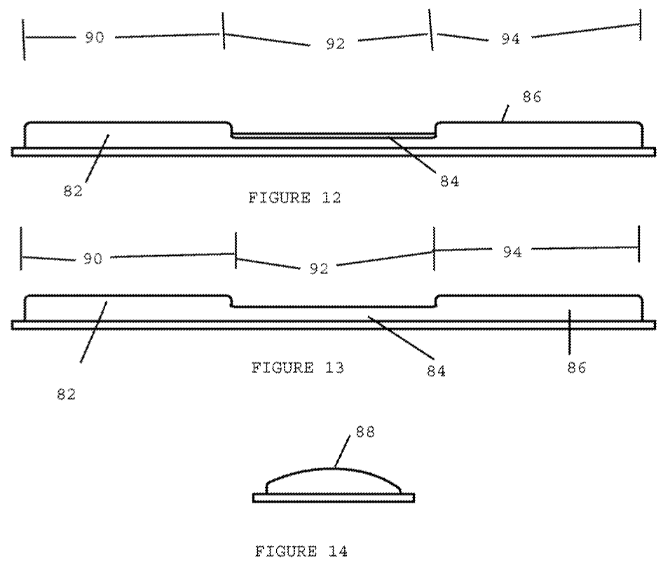

As shown in FIG. 5, the edges (62 and 64) may be rounded. According to another preferred embodiment, the mousing opening cutout (42) is substantially rectangular having four sides and corner is rounded (62, and 64). The edges may also be tapered (70), as shown in FIG. 12. The term tapered is intended to mean that the sides slope, as can be in FIG. 12, the edges are tapered (70) towards the mousing opening cutout. This is desirable for a number of reasons. It guides the fingers towards the mousing device and creates soft corners for mousing.

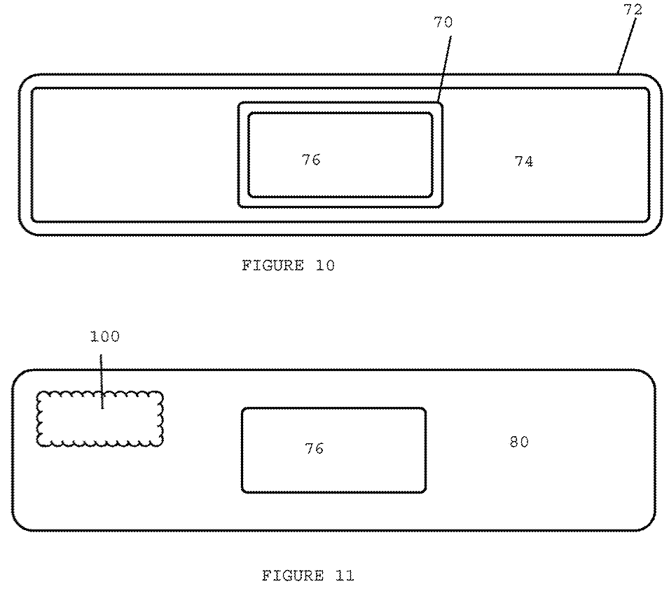

As shown in FIG. 10, the first raised portion (50) and second raised portions (52) may be is curved being elevated towards the center (45) and the mousing opening cutout (42). This is desirable for elevating the hand during mousing and providing a rest for the forearm of the user while using the keyboard.

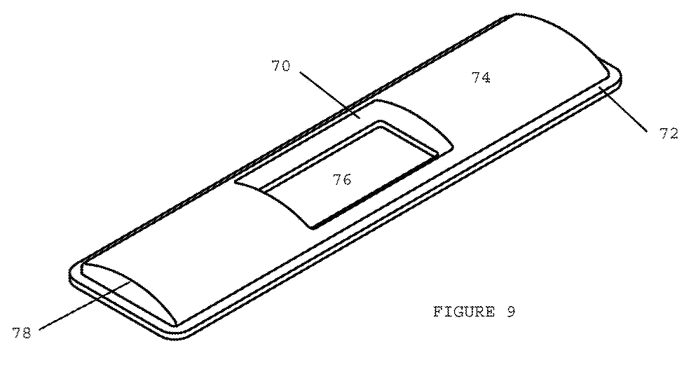

As shown in FIGS. 8-11, an apparatus (75) for relieving soreness, discomfort and prevents repetitive stress on a portion of a user's hand while using a notebook computer is provided, the apparatus (75) comprising: an elongated pad portion (72) smaller in width than the bottom portion of a notebook computer; a mousing opening cutout (76) from the elongated pad portion and adapted to surround the mousing portion of the notebook computer; a first raised portion (74) smaller in length and width than the elongated pad portion (72) and integrally attached to the elongated pad portion (72), wherein the first raised portion (74) is curved being elevated towards the middle (78) and tapered (70) towards mousing opening cutout (76). The top of the raised portion (74) may be at least the same height as the profile of the keys of the keyboard when sitting on the bottom portion of the notebook computer. There may be a thermoplastic polyurethane film (80) in communication with the underside of the elongated pad portion (72) and having a same sized cutout as the mousing opening cutout (76). There may also be an attachment means (100) in communication with the underside of elongated pad portion. The apparatus may be formed from solid polyurethane, PU GEL, visco-elastic polyurethane foam, nylon covered PU GEL or textured solid polyurethane. The mousing opening cutout (76) may be substantially rectangular having four sides.

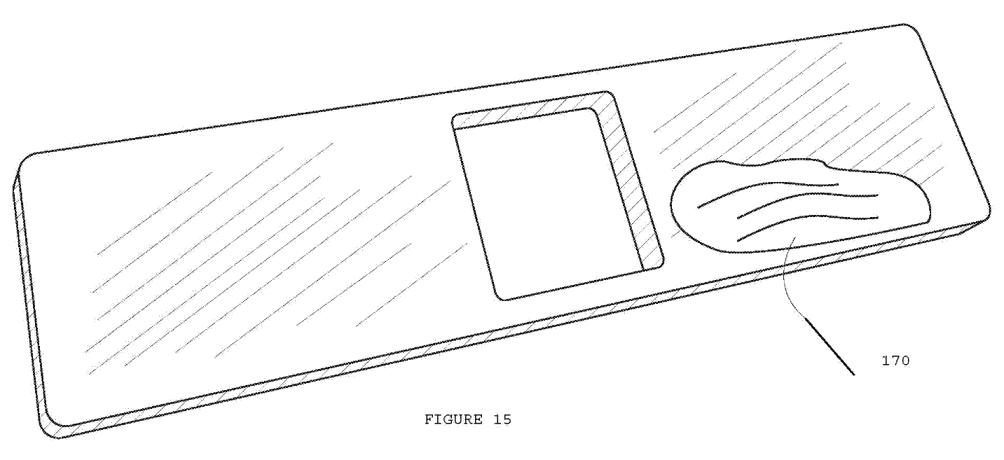

As shown in FIGS. 12-14, the first raised portion may have a left portion (90), center portion (92) and right portion (94), wherein the center portion (92) is lower in height than the left portion (90) and the right portion (94). The first raised portion may be curved being elevated towards the middle (88)

As shown in FIG. 15, there may also be an elevated mound (170) on at least one top side of the elongated pad portion. This is for the receipt of the user's palm during mousing to keep the hand in a position less prone to repetitive stress.

It should be understood that the foregoing relates to preferred embodiments of the invention and that modifications may be made without departing from the spirit and scope of the invention as set forth in the following claims.

I claim:

1. An apparatus for relieving soreness, discomfort and preventing repetitive stress on a portion of a user's hand while using a notebook computer, said apparatus comprising:
an elongated pad portion smaller in width than the bottom portion of said notebook computer;
a mousing opening cutout from said elongated pad portion and adapted to surround the mousing portion of said notebook computer to create a left portion, center portion and right portion;
a first raised portion smaller in length and width than said elongated pad portion and integrally attached to said elongated pad portion along said left portion;
a second raised portion smaller in length and width than said elongated pad portion and integrally attached to said elongated pad portion along said right portion; and
at least one keyboard button opening in said elongated pad portion along said center portion below said mousing opening cutout.

2. An apparatus as in claim 1, wherein the top of said raised portion is at least the same height as the profile of the keys of said keyboard when sitting on said bottom portion of said notebook computer.

3. An apparatus as in claim 1, further comprising a thermoplastic polyurethane film in communication with the underside of said elongated pad portion and having a same sized cutout as said mousing opening cutout.

4. An apparatus as in claim 1, further comprising an attachment means in communication with the underside of said elongated pad portion.

5. An apparatus as in claim 1, wherein said apparatus is formed from solid polyurethane, PU GEL, visco-elastic polyurethane foam, nylon covered PU GEL or textured solid polyurethane.

6. An apparatus as in claim 1, wherein said mousing opening cutout is substantially rectangular having four sides and each side is tapered.

7. An apparatus as in claim 1, wherein said first raised portion and said second raised portion are curved being elevated towards the middle.

8. An apparatus as in claim 1, wherein at least one side of said elongated pad portion is tapered.

9. An apparatus as in claim 1, further comprising an elevated mound on at least one top side of at least one of said first raised portion and said second raised portion.

10. An apparatus as in claim 9, wherein said elevated mound is oval shaped for receiving the user's palm.

11. An apparatus for relieving soreness and preventing repetitive stress on a portion of a user's hand while using a notebook computer, said apparatus comprising:
an elongated pad portion smaller in width than the bottom portion of said notebook computer;
a mousing opening cutout from said elongated pad portion and adapted to surround the mousing portion of said notebook computer;
a first raised portion smaller in length and width than said elongated pad portion and integrally attached to said elongated pad portion, said first raised portion curved being elevated towards the middle and tapered towards said mousing opening cutout.

12. An apparatus as in claim 11, wherein the top of said raised portion is at least the same height as the profile of the keys of said keyboard when sitting on said bottom portion of said notebook computer.

13. An apparatus as in claim 11, further comprising a thermoplastic polyurethane film in communication with the underside of said elongated pad portion and having a same sized cutout as said mousing opening cutout.

14. An apparatus as in claim 11, further comprising an attachment means in communication with the underside of said elongated pad portion.

15. An apparatus as in claim 11, wherein said apparatus is formed from solid polyurethane, PU GEL, visco-elastic polyurethane foam, nylon covered PU GEL, textured solid polyurethane, nylon covered polyfoam or polyester covered polyfoam.

16. An apparatus as in claim 11, wherein said mousing opening cutout is substantially rectangular having four sides.

17. An apparatus as in claim 11, further comprising an elevated mound on at least a portion of said first raised portion.

18. An apparatus as in claim 17, wherein said elevated mound is oval shaped for receiving the user's palm.

19. An apparatus as in claim 11, said first raised portion having a left portion, center portion and right portion, wherein said center portion is lower in height than said left portion and said right portion.
